(19) United States
(12) Patent Application Publication
(10) Pub. No.: US 2003/0044763 A1
(43) Pub. Date: Mar. 6, 2003

(54) Display board

(76) Inventor: Walter Adenau, Edison, NJ (US)

Correspondence Address: Edward M. Fink, Esq., 51 Jamaica Street, Edison, NJ, 08820, US

(21) Appl. No.: 09/942,413

(22) Filed: Aug. 30, 2001

(51) Int. Cl. B43L 1/00

(52) U.S. Cl. 434/408

(57) ABSTRACT

A novel display device suitable for educational purposes includes two rectangular surfaces connected to each other in a V-shape or tent-type relationship and held in place by means of metal O-rings connected through apertures in the upper surfaces of the rectangular materials, A strap member connected to the base of each of the two rectangular surfaces at the central portion thereof serves to permit reversal of the rectangular surfaces, thereby enlarging the scope of use of the display device.

### FIELD OF THE INVENTION

This invention relates to a display board. More specifically, the present invention relates to an educational or illustrative display board suitable for use as an instructional tool in an educational or professional environment.

### DESCRIPTION OF THE PRIOR ART

During the past two decades there has been a birth of interest in the use of visual aides in the for of display devices which are commonly employed in both educational and commercial settings. Thus, for example, it has become common in the business community to employ electronic display boards, either for record keeping purposes or as an instructional tool for illustrating marketing plans, sales programs and the like.

Similarly, in the educational field, it has been the practice of educators to employ a variety of teaching techniques including various types of display vehicles, as for example, chalk boards, magnetic media displayed on conductive surfaces, felt boards, laser media and the like.

Although each of the foregoing techniques has met with a certain degree of success and has been found useful, workers in the art have continued in their search for new media or devices capable of simplifying their mission while enhancing the learning experience of their student body.

### SUMMARY OF THE INVENTION

In accordance with the present invention, this end has been successfully attained by means of a novel display device which affords greater flexibility in the display process that was available heretofore while enhancing portability and increasing the range of the instructional program. The device of interest comprises a V-shaped or tent like structure comprising four lateral faces to which the same or differing material may be attached.

### BRIEF DESCRIPTION OF THE DRAWING

The invention will be more readily understood by reference to the following detailed description taken in conjunction with the accompanying drawing wherein:

FIG. 1. is a front elevational view, partly in perspective, showing a typical display board in accordance with the invention; and

FIG. 2 is a side view of the display board shown in FIG. 1.

### DETAILED DESCRIPTION OF THE INVENTION

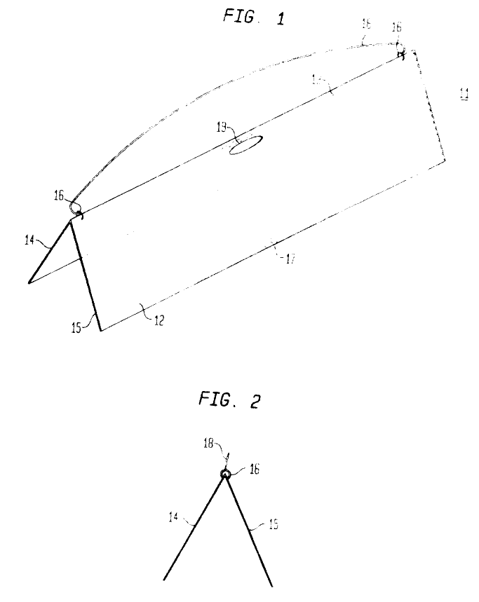

With reference now to FIG. 1, there is shown a typical display board suitable for use in the practice of the present invention. Shown in the figure is display board 11 having lateral faces 12, 13, 14 and 15, each of which may be comprised of the same material or of differing materials. Thus, for example, lateral faces 12, 13, 14 and 15 may be comprised of felt, a magnetic medium, a graphitized chalk board surface, a cork board, a pocket chart assembly comprising a nylon cloth having plastic strips connected thereto which allow printed materials to be placed thereunder which creates a step-like assembly, and the like.

As indicated, the four surfaces of the display device may be the same or, preferably, comprised of differing lateral surfaces to assure maximization of available display options. Thus, it may be of interest in a specific environment to use a combination of a felt board, a cork board, a magnetic surface and a step-type assembly. In practice, the lateral surfaces are affixed to a base member which may be comprised of rigid cardboard, pressed board, a metallic surface such as aluminum or copper, a graphitized surface, a polymeric material such as polyethylene, polyurethane, polyproplyene and the like.

The materials selected for the foregoing purpose are readily available from commercial sources and, after selection, are connected to each other in a V-shape or tent-type relationship and held in place by means of metal O-rings 16 connected through apertures in the upper surfaces of the base material and by means of a strap member 17 connected to the base of each of the two lateral surfaces a the central portion thereof, the strap member typically comprising nylon or any other suitable joining means. The ends of strap 17 may be joined by means of a snap member or by a Velcro connection, etc. This expedient further permits reversal of lateral faces to provide easy access to all four of the lateral surfaces of the display device, thereby enhancing the flexibility and utility of the device.

The dimension of the lateral faces may vary, however, to maintain a manageable size, it has been found practical to employ lateral faces in rectangular shape having dimensions of the order of two feet by three feet. Portability of the desired device may be enhanced by attaching a carrying cord or strap 18 of the type commonly employed in the luggage and carrying case industry, thereby permitting prompt and efficient movement of the display device to alternative sites with a minimum of inconvenience.

A side view of the display device depicted in FIG. 1 is shown in FIG. 2.

While the invention has been described in detail in the foregoing specification, it will be appreciated by those skilled in the art that variations may be made by the artisan without departing from the spirit and scope of the invention. Thus, for example, it will be appreciated that various metallic surfaces may be employed as the base material in addition to alternative types of rigid cardboard without departing from the spirit of the invention.

What is claimed is:

1. A display device including a tent-type structure comprising two lateral faces having an interior lateral surface and an exterior lateral surface, the resultant four lateral surfaces being attached to each other by means of O-rings affixed to each end of their upper surface and by means of a strap member connected to the base of the lateral faces, said strap member being adapted with joining means, each of said four lateral surfaces having affixed thereto an exterior surface selected from the group consisting of a metallic material, felt, a graphitized chalk board surface, a pocket chart adapted to receive textual material, a cork board and a polymeric material.

2. Display device in accordance with claim 1 further comprising a carrying strap affixed thereto.

3. Display device in accordance with claim 1 wherein the exterior surfaces of the lateral faces comprise felt, a conductive metal, a graphitized surface and a pocket chart.

4. Display device in accordance with claim 1 wherein the exterior faces of the lateral faces comprise polyethylene, aluminum, felt and a pocket chart.
